(19) United States
(12) Patent Application Publication
(10) Pub. No.: US 2010/0270233 A1
(43) Pub. Date: Oct. 28, 2010

(54) WATER PURIFYING FILTER AND METHOD FOR FABRICATING THE SAME

(76) Inventors: Sang Hoon Kim, Seoul (KR); Hyung Ki Hong, Anyang-si (KR); Sung Su Han, Seoul (KR)

Correspondence Address: BIRCH STEWART KOLASCH & BIRCH, PO BOX 747, FALLS CHURCH, VA, 22040-0747, US

(21) Appl. No.: 12/765,748

(22) Filed: Apr. 22, 2010

(30) Foreign Application Priority Data
Apr. 22, 2009 (KR) 10-2009-0035001
Sep. 22, 2009 (KR) 10-2009-0089463

(51) Int. Cl. B01D 69/10; B05D 5/00

(52) U.S. Cl. 210/490; 427/244

(57) ABSTRACT

A water purifying filter and method for fabricating the same are disclosed. The water purifying filter includes a support substrate, a pattern formed on the support substrate to have at least one hole, membrane protein of an aquaporin group coated on the pattern and a protective layer formed on polymer pattern having the membrane protein coated thereon.

This application claims the benefit of Korean Application No. 10-2009-0035001, filed on Apr. 22, 2009, and Korean Application No. 10-2009-0089463, filed on Sep. 22, 2009, which are hereby incorporated by reference as if fully set forth herein.

### BACKGROUND OF THE DISCLOSURE

1. Field of the Disclosure

The present invention relates to a water purifying filter and a method for fabricating the same.

2. Discussion of the Related Art

Though water is the most essential resource the human-being can not dispense with, the U.N. predicts that about 2.7 billion people will confront with shortage of fresh water by 2025 due to increased population and rapid increase of industrial water consumption, and ⅕ of countries in the world experience serious water shortage.

The problem of water pollution becomes serious due to acceleration of industrialization and urbanization, and according to the World Water Forum, 1.1 billion people fail to drink safe water, and 5 million people die every year from water-borne diseases, presently.

In order to solve the water shortage problem, there have been researches for development of a water purifying filter that can purify polluted water into potable water.

In the case of a related art reverse osmosis (RO) type filter which can filter all impurities, a pressure higher than an osmosis pressure is applied to polluted water or a high concentration solution to make water therein to move to a side of a low concentration solution for purifying the water.

The RO type filter is provided with a supporting substrate formed on non-woven fabric, and polyamide which is an active layer is formed on the supporting substrate by interfacial polymerization reaction for removing pollutants.

The RO type consumes electric energy for applying the pressure higher than the osmosis pressure to the polluted water and requires a storage tank for collecting water as the RO type has a low water permeability.

### SUMMARY OF THE DISCLOSURE

Accordingly, the present invention is directed to a water purifying filter and a method for fabricating the same that substantially obviates one or more problems due to limitations and disadvantages of the related art.

Additional advantages, objects, and features of the disclosure will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a water purifying filter includes a support substrate, a pattern formed on the support substrate to have at least one hole, membrane protein of an aquaporin group coated on the pattern and a protective layer formed on polymer pattern having the membrane protein coated thereon.

The support substrate may be constructed of an ultrafiltration or microfilteration containing a polymer group substance such as polysulfone or Teflon having pores, or formed of ceramic, metal, or carbon other than the polymer group.

The membrane protein may be an aquaporin vesicle incorporated in one of substances selected from a lipid bi-layer and block copolymer, or is formed as the aquaporin is coated in the lipid bi-layer or the block copolymer.

The pattern may be formed by using a mask or a mold.

The membrane protein of the aquaporin group may be a membrane protein of at least one of groups of the aquaporin 1˜12, aquaporin-Z, and aquaporin-M.

In another aspect of the present invention, a method for fabricating a water purifying filter includes forming a support substrate, forming a pattern on the support substrate to have at least one hole, coating membrane protein of an aquaporin group on the pattern and forming a protective layer on the pattern having the membrane protein coated thereon.

The support substrate may be constructed of an ultrafiltration or microfilteration containing a polymer group substance such as polysulfone or Teflon having pores, or formed of ceramic, metal, or carbon other than the polymer group.

The membrane protein may be an aquaporin vesicle incorporated in one of substances selected from a lipid bi-layer and block copolymer, or is formed as the aquaporin is coated in the lipid bi-layer or the block copolymer.

The pattern may be formed by using a mask or a mold.

The membrane protein of the aquaporin group may be a membrane protein of at least one of groups of the aquaporin 1˜12, aquaporin-Z, and aquaporin-M.

In another aspect of the present invention, a water purifying filter includes a first substrate, a pattern formed on the first substrate to have a plurality of holes, a second substrate having the pattern transcribed thereto, membrane protein of an aquaporin group coated on the pattern transcribed to the second substrate and a protective layer formed on the second substrate having the membrane protein coated thereon.

The first substrate may be a polyethylene terephthalate (PET) substrate and the second substrate is a porous substrate.

The pattern may be formed from a first film and a second film formed on the first substrate in succession, wherein the first film is formed of a water soluble polymer substance and the second film is an ultraviolet (UV)-cured substance.

The water purifying filter may further include a self assembled monolayer (SAM) substance coated on the second substrate and the pattern.

The membrane protein may be an aquaporin vesicle incorporated in one of substances selected from a lipid bi-layer and block copolymer, or is formed as the aquaporin is coated in the lipid bi-layer or the block copolymer.

In another aspect of the present invention, a method for fabricating a water purifying filter includes coating a first film and a second film on a first substrate, forming a pattern on the films coated thus, transcribing the pattern formed thus to a second substrate, removing the first substrate and the first film, and coating membrane protein of an aquaporin group to the pattern transcribed thus and forming a protective layer on the second substrate having the membrane protein coated thereon.

The first substrate may be a polyethylene terephthalate (PET) substrate and the second substrate is a porous substrate.

The first film may be formed of a water soluble polymer substance and the second film is an ultraviolet-cured substance.

The method may further include a self assembled monolayer (SAM) substance coated on the second substrate and the pattern.

The membrane protein may be an aquaporin vesicle incorporated in one of substances selected from a lipid bi-layer and block copolymer, or is formed as the aquaporin is coated in the lipid bi-layer or the block copolymer.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 illustrates a diagram of aquaporin incorporated in a lipid bi-layer according to an embodiment of the present invention;

FIGS. 2A to 2C illustrate sections showing the steps of a method for fabricating a water purifying filter using of aquaporin according to a first embodiment of the present invention;

FIG. 3 illustrates a vesicle of aquaporin incorporated in a lipid bi-layer or a block copolymer according to an embodiment of the present invention;

FIGS. 4A to 4D illustrate sections showing the steps of a method for fabricating a water purifying filter of aquaporin according to a second embodiment of the present invention;

FIGS. 5A to 5D illustrate sections showing the steps of a method for fabricating a water purifying filter of aquaporin according to a third embodiment of the present invention;

FIGS. 6A to 6D illustrate sections showing the steps of a method for fabricating a water purifying filter of aquaporin according to a fourth embodiment of the present invention;

FIGS. 7A to 7I illustrate sections showing the steps of a method for fabricating a water purifying filter of aquaporin according to a fifth embodiment of the present invention;

FIGS. 8A to 8G illustrate sections showing the steps of a method for fabricating a water purifying filter of aquaporin according to a six embodiment of the present invention; and

FIGS. 9A and 9B illustrate sections showing an example of the steps of a method for fabricating a water purifying filter of an SAM substance according to an embodiment of the present invention.

### DESCRIPTION OF SPECIFIC EMBODIMENTS

Reference will now be made in detail to the specific embodiments of the present invention, examples of which are illustrated in the accompanying drawings. Wherever possible, the same reference numbers will be used throughout the drawings to refer to the same or like parts. In addition, although the terms used in the present invention are selected from generally known and used terms, some of the terms mentioned in the description of the present invention have been selected by the applicant at his or her discretion, the detailed meanings of which are described in relevant parts of the description herein. Furthermore, it is required that the present invention is understood, not simply by the actual terms used but by the meaning of each term lying within.

In the meantime, it is required to understand that, in a case of description that a layer, a film, a region, a plate, or the like part is formed or positioned “on” other part, the description implies, not only a case the part is formed right on the other part in direct contact thereto, but also a case another part exists between the parts.

The water purifying filter and a method for fabricating the same of the present invention will be described.

In order to help understanding of the present invention and convenience of description, the specification will be described, taking a water purifying filter of membrane protein of an aquaporin group or an SAM (self assembled monolayer) as an example.

In the present invention, a water purifying filter membrane can be fabricated by forming different patterns on a thin substrate. For fabrication of the membrane, the polymer pattern transcription technology or the track back etch technology can be used. However, the track back etch technology has disadvantage in that an overall cost for fabrication of the water purifying filter increases due to the great difficulty of formation of a few nanometer to a few tens of nanometer holes in very thin substrate at fixed intervals, the very complicate steps required for formation of nanometer sized pores, and the requirement for a semiconductor process which requires a high cost. Accordingly, the specification will describe the present invention taking a method in which the nanometer sized pores are formed on a substrate by using the polymer pattern transcription technology easily, and the membrane is formed by using the membrane protein of the aquaporin group or the SAM as an example. The membrane produced thus can be modularized in different types for fabrication of adaptive filters.

Various embodiments of a membrane formation process for fabrication of the water purifying filter will be described with reference to the drawings attached hereto.

A method for forming a membrane of membrane protein of the aquaporin group in accordance with a preferred embodiment of the present invention will be described. At first, the aquaporin will be described.

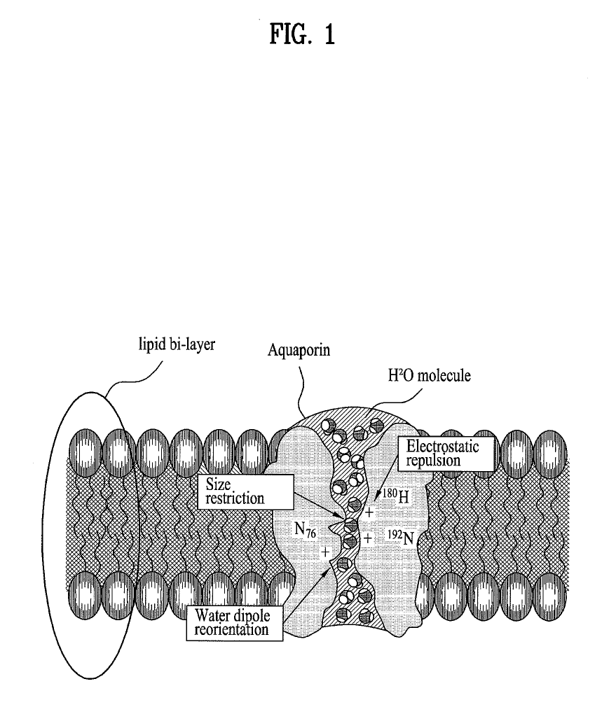

FIG. 1 illustrates a diagram of aquaporin incorporated in a lipid bi-layer in accordance with a preferred embodiment of the present invention.

The aquaporin not only excludes pass of all pollutants, such as bacteria, virus, mineral, salt, and so on, but allows pass of water owing to a structural characteristic thereof.

The aquaporin is membrane protein having around 300 amino acid and a cell symmetric with respect to an inside to and outside thereof. Especially, the aquaporin has a very small sand glass shaped center portion. For an example, the smallest portion of the center portion of the aquaporin has a size of about 3 Å which is slightly greater than a water molecule H₂O having a size of 2.8 Å. Accordingly, an aquaporin NPA box having two alanines arranged in a water passage in parallel blocks pass of a hydrogen ion H⁺, but allows pass of the water molecule H₂O, only.

Thus, the aquaporin interferes with pass of other ion or solute, but induces in/out of the water molecule, selectively. Owing to such a characteristic, the aquaporin is also called as a water channel.

The aquaporin has six transmembrane α-helices arranged in a clockwise direction, having amino acid and carboxy extremities on a cytoplasm side surface of the membrane. The amino acid and the carboxy half show similarity to a tandem repeat.

The aquaporin has five A˜E interhelical loops on outside and inside of the cell, wherein the loops B and E maintain Asn-Pro-Ala NPA motif, though it is inadequate as a hydrophobia, to form a three dimensional sand glass shape, allowing the water to pass therethrough. There are the NPA motif and a selectivity filter or an ar/R selectivity filter which are smaller than the NPA motif.

The aquaporin passes water and uncharged solute, such as glycerol, carbon dioxide CO₂, ammonia, urea, and so on depending on a size of a gap.

The aquaporin differs with peptide sequences which change a hole size in the protein. The hole size is influenced to a size of the molecule which passes therethrough. However, a water pore shows no permeability to a charged molecule, i.e., a proton or particles having an electro-chemical characteristic.

Since movement of the water is symmetric in the aquaporin, allows moving in any direction, and needs no energy consumption, such movement can be a great advantage for a production of a water filter of the aquaporin. However, in relation to the present invention, for applying the aquaporin to a water purifying filter actually to use the aquaporin as the water purifying filter which selectively passes water only, endurance of the aquaporin against water pressure is very important.

In a case vesicles may be formed by incorporating the aquaporin in block copolymers to construct a three dimensional structure simply, and in another case monolayer of the lipid bi-layer is formed for fabrication of two dimensional planer type water purifying filter. However, since the three dimensional structure requires large amounts of the aquaporins and the block copolymers, extending moving passages of the water, a permeation rate of the water becomes poor. Moreover, the two dimensional planer type has problems of endurance of the aquaporin against to the water pressure and requirement of a much fabrication time period for mixing by using vesicle fusion technology.

Accordingly, in the present invention, micro or nano patterns are formed on a surface of the support layer or support substrate of the water purifying filter so that the micro or nano patterns do not take entire pressure directly in fabrication of the water purifying filter for improving the endurance compared to the planer type, making the fabrication time period short and improving an anti-fouling characteristic. The water purifying filter of aquaporin of the present invention can reduce the amount of the block copolymers used for fabrication compared to the three dimensional structure, and increase the permeation rate owing to the short water moving passage.

A process for formation of a membrane by using the membrane protein of the aquaporin group, and fabricating the water purifying filter of the membrane formed thus will be described. However, the membrane can be modulized in different type of modules for fabrication of the water purifying filter as required.

### First Embodiment

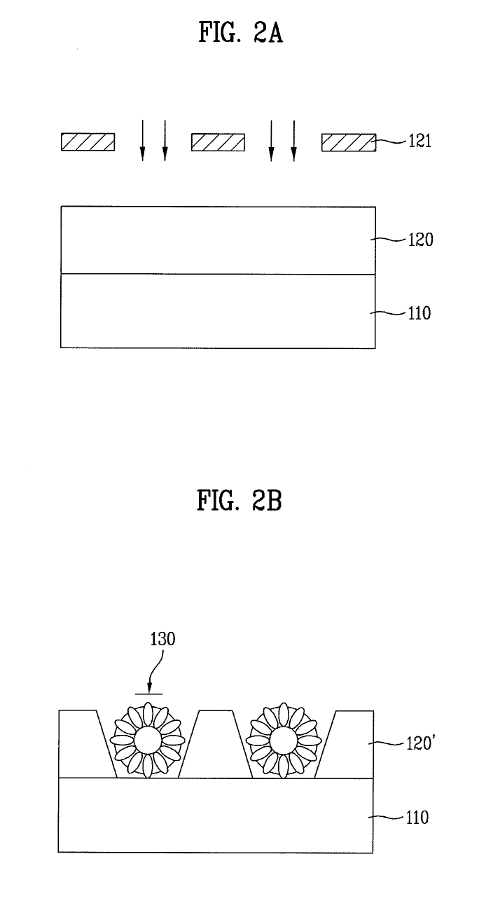

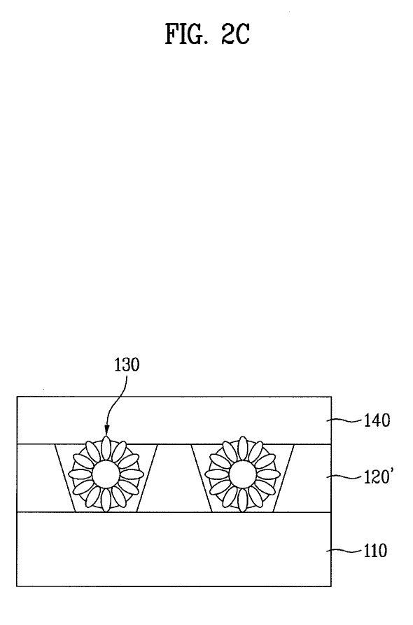

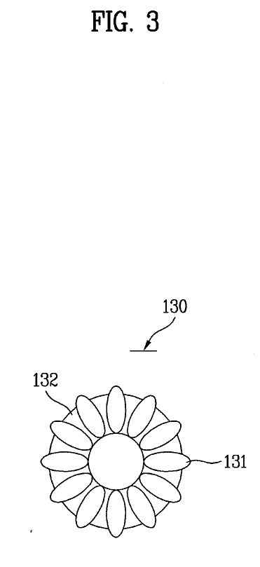

FIGS. 2A to 2C illustrate sections showing the steps of a method for fabricating a water purifying filter using aquaporin according to an embodiment of the present invention. FIG. 3 illustrates a vesicle of aquaporin incorporated in a lipid bi-layer or a block copolymer according to a first embodiment of the present invention.

Referring to FIG. 2A, the steps of a method for fabricating a water purifying filter according to a first embodiment of the present invention includes coating a polymer substance 120 on a support substrate 110, positioning a mask 121 on the polymer substance, and subjecting the support substrate 110 to exposure and development to form polymer pattern 120′ having at least one intaglio in the polymer substance 120. Though not shown in FIG. 2A, the polymer pattern 120′ may be formed by molding.

The support substrate 110 can be constructed of an ultrafiltration or microfilteration containing a polymer group substance such as polysulfone or Teflon having pores, or formed of ceramic, metal, or carbon other than the polymer group.

The intaglio may be of a two dimensional hole or one dimensional grid pattern. In this instance, if the intaglio has the two dimensional hole pattern, an interval of the intaglio can be 20 nm to 10 μm, and the hole may have a size of 5 to 200 nm. If the intaglio has the one dimensional grid pattern, the intaglio can have a step of 20 nm to 500 μm, with an interval of 20 nm to 500 μm and a line width of 10 to 250 μm.

Then, referring to FIG. 2B, a solution containing vesicles 130 of membrane protein of the aquaporin group is injected into the intaglio in the polymer pattern 120′, and dried. In this instance, the membrane protein of the aquaporin group can be membrane protein selected from at least one of groups of the aquaporin 1˜12, aquaporin-Z, and aquaporin-M. The intaglio may have a slope such that the intaglio has a shape which has, for an example, a small bottom side and a great upper side for preventing the vesicles 130 from passing through.

Referring to FIG. 3, the aquaporin vesicle 130 of the present invention is a vesicle having the aquaporins 131 incorporated in a lipid bi-layer 132 or a block copolymer 132. The block copolymer 132 can be at least one polymer group selected from Poly(ethylene oxide), Poly(ethylene propylene), Poly(2-methyloxazoline), Poly(propylene sulfide), and Poly(dimethylsiloxane).

Finally, referring to FIG. 2C, a protective layer 140 of a hydrophilic polymer group is formed on the polymer pattern 120′ having the aquaporin vesicles 130 injected therein.

### Second Embodiment

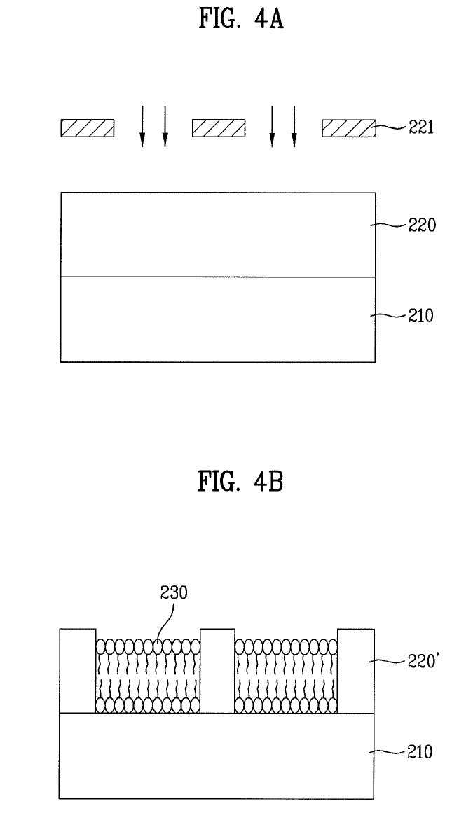

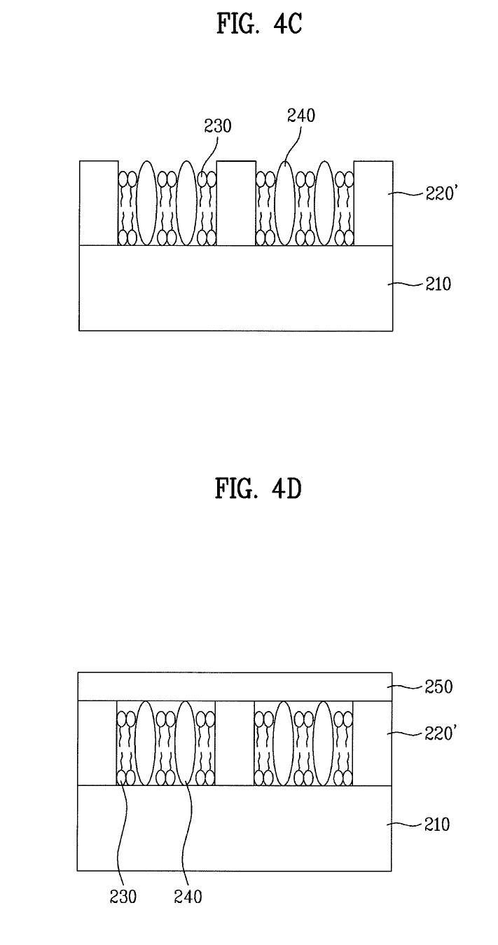

FIGS. 4A to 4D illustrate sections showing the steps of a method for fabricating a water purifying filter of aquaporin according to a second embodiment of the present invention.

Referring to FIG. 4A, the steps of a method for fabricating a water purifying filter according to a second embodiment of the present invention includes coating a polymer substance 220 on a support substrate 210, positioning a mask 221 on the polymer substance 220, and subjecting the support substrate 210 to exposure and development to form at least one polymer pattern 220′ having at least one intaglio in the polymer substance 220. Though not shown in FIG. 4A, the polymer pattern 220 may be formed by molding.

The support substrate 210 can be constructed of an ultrafiltration or microfilteration containing a polymer group substance such as polysulfone or Teflon having pores, or formed of ceramic, metal, or carbon other than the polymer group.

The intaglio may be of a two dimensional hole or one dimensional grid pattern. In this instance, if the intaglio has the two dimensional hole pattern, an interval of the intaglio can be 20 nm to 10 μm, and the hole may have a size of 5 to 200 nm. If the intaglio in the polymer pattern 220 has the one dimensional grid pattern, the intaglio can have a step of 20 nm to 500 μm, with an interval of 20 nm to 500 μm and a line width of 10 to 250 μm.

Then, referring to FIG. 4B, a lipid bi-layer 230 or a block copolymer 230 is coated in the intaglio. FIG. 4B illustrates the lipid bi-layer 230 coated in the intaglio.

Next, referring to FIG. 4C, the aquaporin 240 is coated in the intaglio having the lipid bi-layer 230 or the block copolymer 230 coated therein.

Finally, referring to FIG. 4D, a protective layer 250 of a hydrophilic polymer group is formed on the polymer pattern 220′ having the aquaporin 240 coated thereon.

Thus, the second embodiment can shorten a fabrication process time period by injecting the aquaporin 240 into the intaglio after coating the lipid bi-layer or the block copolymer 230 in the intaglio in the polymer pattern instead of incorporation of the aquaporin vesicles 130 in the lipid bi-layer or block copolymer in the first embodiment.

### Third Embodiment

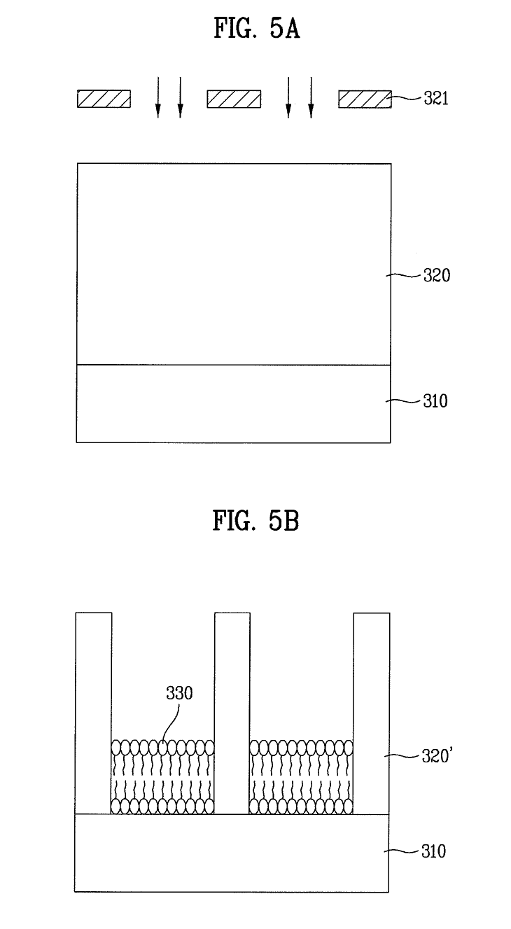

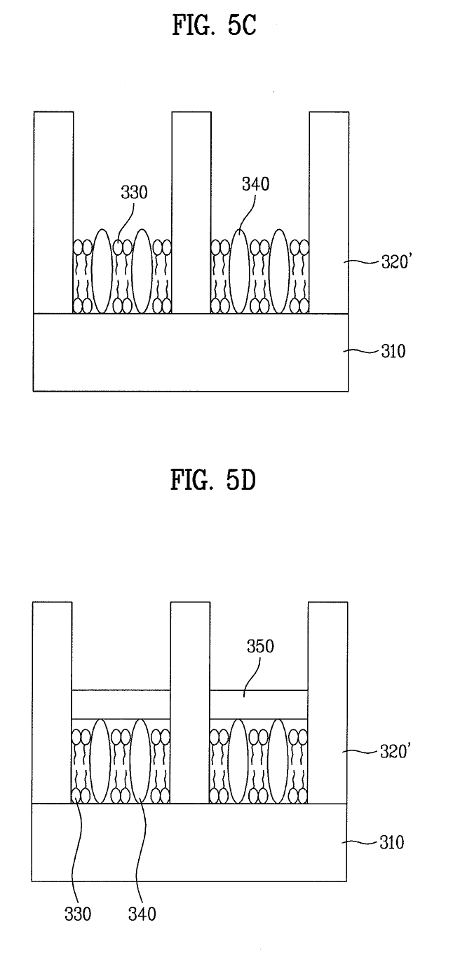

FIGS. 5A to 5D illustrate sections showing the steps of a method for fabricating a water purifying filter of aquaporin according to a third embodiment of the present invention.

Referring to FIG. 5A, the steps of a method for fabricating a water purifying filter 300 according to a third embodiment of the present invention includes coating a polymer substance 320 on a support substrate 310, positioning a mask 321 on the polymer substance 320, and subjecting the support substrate 310 to exposure and development to form polymer pattern 320′ having at least one intaglio in the polymer substance 320. Though not shown in FIG. 5A, the polymer pattern 320 may be formed by molding.

The support substrate 310 can be constructed of an ultrafiltration or microfilteration containing a polymer group substance such as polysulfone or Teflon having pores, or formed of ceramic, metal, carbon and so on other than the polymer group.

The intaglio may be of a two dimensional hole or one dimensional grid pattern. In this instance, if the intaglio has the two dimensional hole pattern, an interval of the intaglio can be 20 nm to 10 μm, and the hole may have a size of 5 to 200 nm. The polymer pattern 320 of the third embodiment has a height formed greater than the height in the first or second embodiment. That is, if the intaglio is of the one dimensional grid pattern, the intaglio can have a step of 40 nm to 1000 μm.

Then, referring to FIG. 5B, a lipid bi-layer 330 or a block copolymer 330 is coated in the intaglio. FIG. 5B illustrates the lipid bi-layer 330 coated in the intaglio. In this instance, the coating of the lipid bi-layer 330 or the block copolymer 330 is to be below a surface of the polymer pattern 320′.

Next, referring to FIG. 5C, the aquaporin 340 is coated in the intaglio having the lipid bi-layer 330 or the block copolymer 330 coated therein.

Finally, referring to FIG. 5D, a protective layer 350 of a hydrophilic polymer group is formed on the polymer pattern 320 having the aquaporin 340 coated thereon.

Thus, the third embodiment can shorten a fabrication process time period by injecting the aquaporin 340 into the intaglio after coating the lipid bi-layer or the block copolymer 330 in the intaglio in the polymer pattern 320 instead of incorporation of the aquaporin vesicles 130 in the lipid bi-layer or block copolymer in the first embodiment.

By forming the height of the polymer pattern 320 higher than the same in the first or second embodiment, the water purifying filter of the third embodiment can induce anti-fouling.

Though FIGS. 5A to 5D illustrate only one layer formed in the polymer pattern, two or more than two layers can be formed by the same method and in the same type if required. Moreover, concentration of the vesicles in each of the layers may different from each other. That is, an upper layer of may be formed coarse, and a lower layer may be formed dense, or vice versa.

### Fourth Embodiment

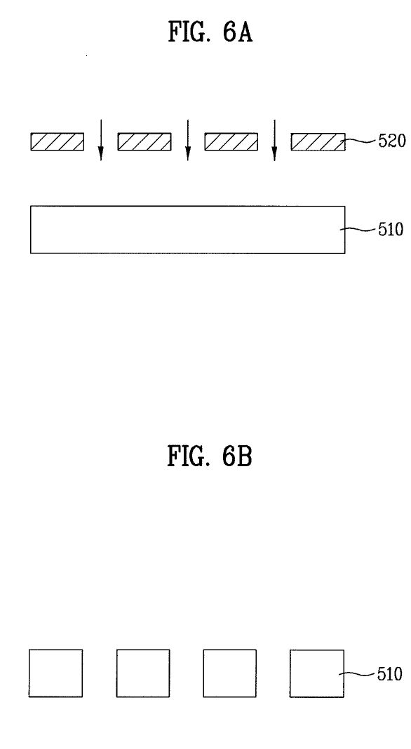

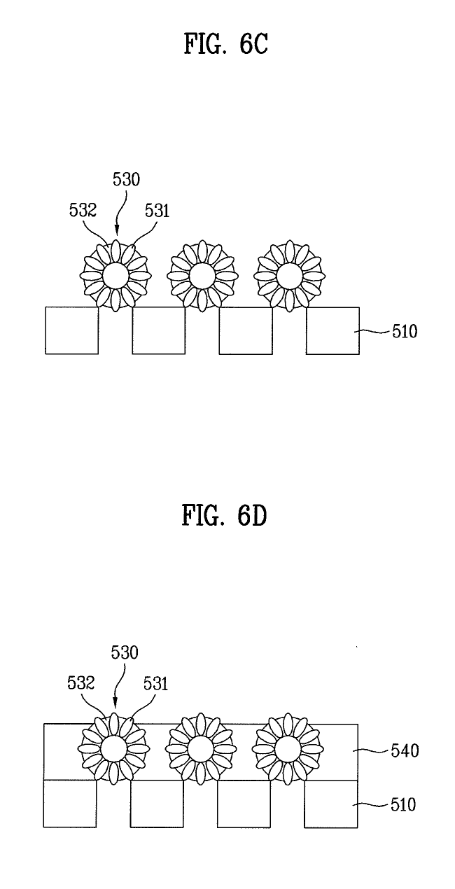

FIGS. 6A to 6D illustrate sections showing the steps of a method for fabricating a water purifying filter of aquaporin according to a fourth embodiment of the present invention.

Referring to FIGS. 6A and 6B, the steps of a method for fabricating the water purifying filter 500 according to a fourth embodiment of the present invention includes positioning of a mask 520 on a support substrate 510 over a permeable membrane which can pass water, and subjecting the support substrate 510 to exposure and development to form the support substrate 510′ having at least one hole.

The support substrate 510 can be constructed of an ultrafiltration or microfilteration containing a polymer group substance such as polysulfone or Teflon having pores, or formed of ceramic, metal, carbon and so on other than the polymer group.

The hole may have a size of 10 to 200 nm.

In the meantime, the permeable membrane may be constructed of non-woven fabric or may not be provided depending on cases.

Then, referring to FIG. 6C, aquaporin vesicles 530 having aquaporin incorporated in a lipid bi-layer 532 or a block copolymer 532 are coated on the holes in the support substrate 510′. In this instance, the aquaporin vesicle 530 is formed greater than the hole in the support substrate 510′ so that the aquaporin vesicle 530 does not sink in the support substrate 510′.

Finally, referring to FIG. 6D, a protective layer 540 of a hydrophilic polymer group is formed on the support substrate 510′ including the aquaporin vesicles 530.

### Fifth Embodiment

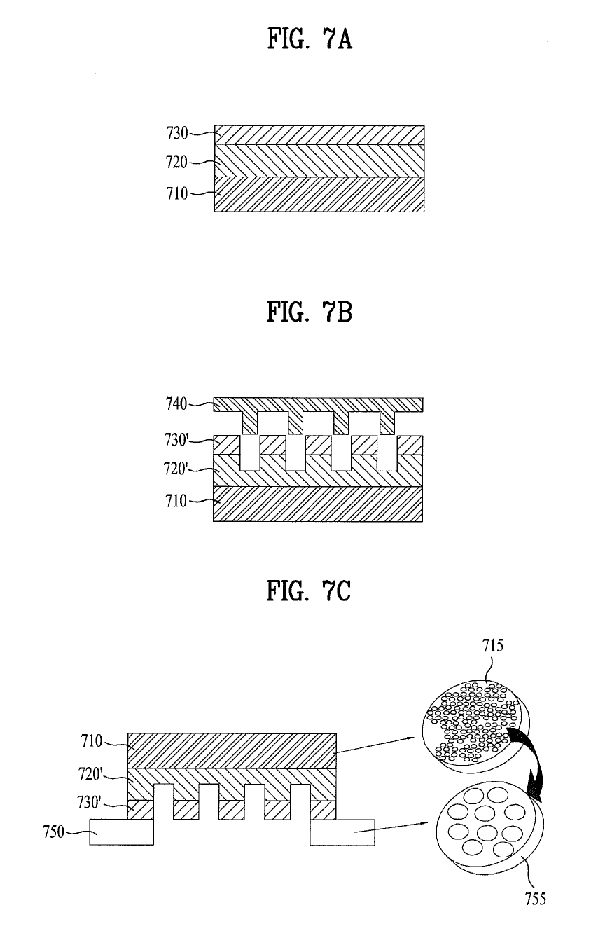

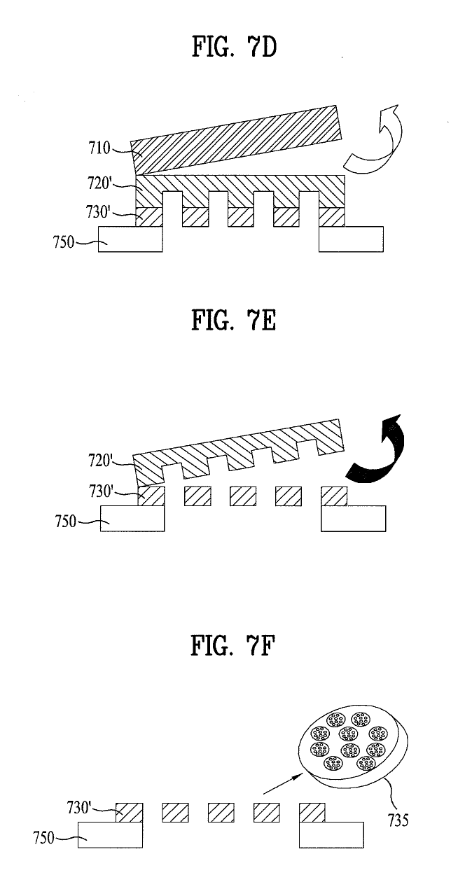

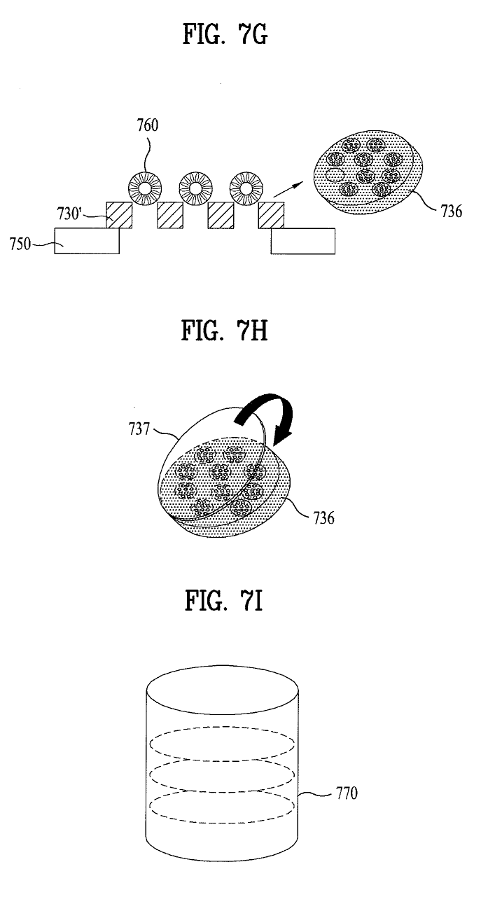

FIGS. 7A to 7I illustrate sections showing the steps of a method for fabricating a water purifying filter of aquaporin according to a fifth embodiment of the present invention. In description of FIGS. 7A to 7I, FIG. 3 will be referred.

In the fifth preferred embodiment of the present invention, a case will be described, in which a disk type module of aquaporin membranes is fabricated.

The steps (FIGS. 7A to 7I) of a method for forming the aquaporin membrane to be used in the disk type module, and the steps (FIG. 7I) of a method for fabricating the disk type module of aquaporin membranes will be described in succession, with reference to the drawings attached hereto.

FIG. 7A illustrates the step of coating a film on a first substrate 710. The film coating can be made two times. At first, a first film 720 is coated on the first substrate 710, and a second film 720 may be coated on the first film 720 coated thus. The first substrate 710 may be a PET (polyethylen terephthalate) substrate, and the first substrate 710 may have a surface treated with plasma before coated with the first film 720. The first film 720 may be a water soluble substance, for an example, a PVA (Polyvinyl alcohol) group polymer substance. The second film 720 may be an ultraviolet (UV)-curable substance.

FIG. 7B illustrates the step of forming a pattern on the film 720 and 730 coated on the first substrate 710 thus. In this instance, for convenience's sake, description of the pattern will be made taking the two dimensional hole pattern as an example. However, the pattern is not limited to the two dimensional hole pattern, but may be the one dimensional grid pattern or a three dimensional structure. In order to form a desired pattern, the pattern is formed, for an example, down to a predetermined depth of the first film 720, penetrating through the second film 730. In this instance, the predetermined depth may be an extent of depth at which, for an example, the pattern does not penetrate through the first film 720, i.e., the pattern is not in contact with the first substrate 710 under the first film 720. Moreover, one or more than one pattern can be formed at fixed intervals. With regard to the pattern, in general, a water channel has a size of a few nanometers nm to a few tens of micrometers μm. However, for convenience's sake, the specification will be described taking a case when the hole patterns are formed at 20 nm to 10 μm intervals as an example. In this instance, the hole may have a size of, for an example, 5 nm to 200 nm. If the pattern has a partition structure or one dimensional grid structure, the pattern may have a step of, for an example, 20 nm to 500 μm, and a line width of 10 μm to 250 μm. The hole pattern may be molded by using a mold 740. The mold 740 may be formed of, for an example, quartz, nickel, silicon oxide, and the like.

FIG. 7C illustrates the step of transcribing the hole pattern formed in the step of FIG. 7B to a second substrate 750. That is, the hole pattern formed in the step of FIG. 7B is adhered to the second substrate 750, and subjected to UV-curing, for transcribing. Different from the first substrate 710, the second substrate 750 can be a porous substrate 755.

FIGS. 7D and 7E illustrate sections showing the steps of peeling off the first substrate 710 and the first film 720′ in succession after the hole pattern transcription to the second substrate 750 is done, respectively. This is a step for remaining only a desired pattern. To do this, the first film 720′ may be dissolved in water for separating and remaining a desired polymer pattern, i.e., the second film 730′.

FIG. 7F illustrates a section showing the step of forming an aquaporin securing pattern having the second substrate 750 and the second film 730′ after removing the first substrate 710 and the first film 720′.

Thus, the aquaporin securing pattern is formed in the steps of FIGS. 7A to 7F by the polymer transcribing technology of the present invention.

FIG. 7G illustrates sections showing the steps of coating aquaporin vesicles 760 on the aquaporin securing pattern formed in the foregoing steps, and securing the aquaporin vesicles 760 coated thus to the second film 730′. The aquaporin vesicle 760 coated on the second film 730′ can have a structure, for an example, of FIG. 3. The membrane protein of the aquaporin group can be membrane protein selected from at least one of groups of the aquaporin 1˜12, aquaporin-Z, and aquaporin-M. Moreover, as shown in FIG. 3, the aquaporin vesicle 330 is a vesicle having the aquaporin 331 incorporated in a lipid bi-layer 332, or a block copolymer 332. The block copolymer 332 is at least one of polymer groups selected from Poly(ethylene oxide), Poly(ethylene propylene), Poly(2-methyloxazoline), Poly(propylene sulfide), and Poly(dimethylsiloxane).

Referring to FIG. 7H, after securing the aquaporin vesicles 760 to the second film 730′, a protective layer 737 is formed so that the aquaporin vesicles 760 do not move, thereby finishing formation of an aquaporin membrane 736.

FIG. 7I illustrates a perspective view of a cylindrical disk type water purifying filter 770 according to a fifth embodiment of the present invention, in which multiple layers of the aquaporin membranes formed in the steps of FIGS. 7A to 7H are arranged to form the cylindrical disk type water purifying filter 770, whereby permitting to have a secure and excellent water purifying effect.

### Sixth Embodiment

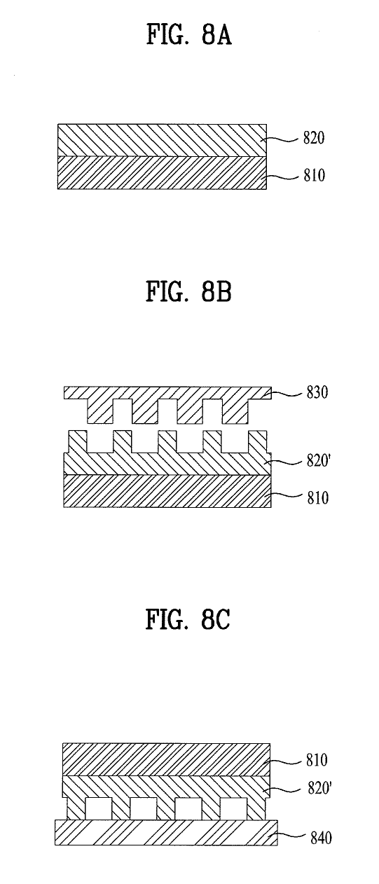

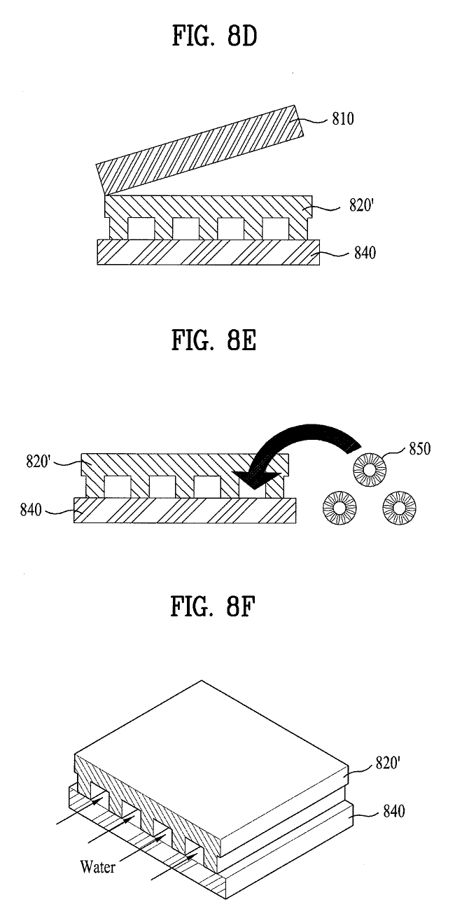

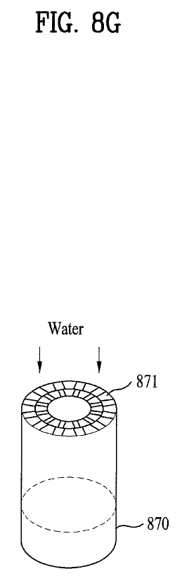

FIGS. 8A to 8G illustrate sections showing the steps of a method for fabricating a water purifying filter of aquaporin according to a six embodiment of the present invention.

In the sixth embodiment of the present invention, a case will be described, in which a spiral type module of aquaporin membranes is fabricated.

The steps (FIGS. 8A to 8F) of a method for forming the aquaporin membrane to be used in the spiral type module, and the steps (FIG. 8G) of a method for fabricating the spiral type module of aquaporin membranes will be described in succession, with reference to the drawings attached hereto.

FIG. 8A illustrates the step of coating a film 820 on a first substrate 810. The first substrate 810 may be a water soluble polymer substance, for an example, a PVA (Polyvinyl alcohol) group polymer substance. The film 820 may be an ultraviolet (UV)-curable polymer substance.

FIG. 8B illustrates the step of forming a pattern on the film 820 coated on the first substrate 810 thus. In this instance, for convenience's sake, description of the pattern will be made taking one dimensional grating pattern as an example. The pattern may have a size, for an example, the same with the aquaporin vesicle formed thus, or a few nanometers to a few tens of nanometers smaller than the aquaporin vesicle. However, the example is not limited to a pattern or a size of the pattern.

In the specification, the one dimensional pattern may be molded by using a mold 830. The mold 830 may be formed of, for an example, quartz, nickel, and silicon oxide, and the like.

FIG. 8C illustrates the step of transcribing the one dimensional pattern to a second substrate 840. For convenience's sake, the second substrate 840 will be described, taking a flexible support substrate as an example.

FIG. 8D illustrates a section showing the steps of peeling off the first substrate 810. This is a step for remaining only a desired pattern 820′, i.e., only the film. To do this, since the first substrate 810 is soluble in water, the first substrate 810 can be removed by dissolving the first substrate 810 in water.

FIG. 8E illustrates a section showing the step of filling the aquaporin vesicles in a desired pattern 820′, i.e., nano-channels formed thus. In the step, the aquaporin vesicles are filled in the channels.

FIG. 8F illustrates a perspective view showing the step of introducing water to, and purifying the water at, the membranes formed by the steps of up to the step of FIG. 8E.

FIG. 8G illustrates a perspective view of a spiral type water purifying filter 870 in accordance with the sixth preferred embodiment of the present invention. The water flows from a top to a bottom, with a top view 871 identical to FIG. 8F if a direction of water flow is taken into consideration.

In this instance, by coating protective layers each having pores smaller than a size of the vesicle at opposite ends of the channel respectively, escape of the vesicles can be prevented.

Thus, the steps of formation of the membrane of the membrane protein of an aquaporin group and the steps of fabrication of the water purifying filter of the membrane formed thus in accordance with the present invention have been described.

### Seventh Embodiment

Next, the steps of forming a membrane of an SAM (Self Assembled Monolayer) substance and the steps of fabricating a water purifying filter of the membranes formed thus in accordance with the present invention will be described.

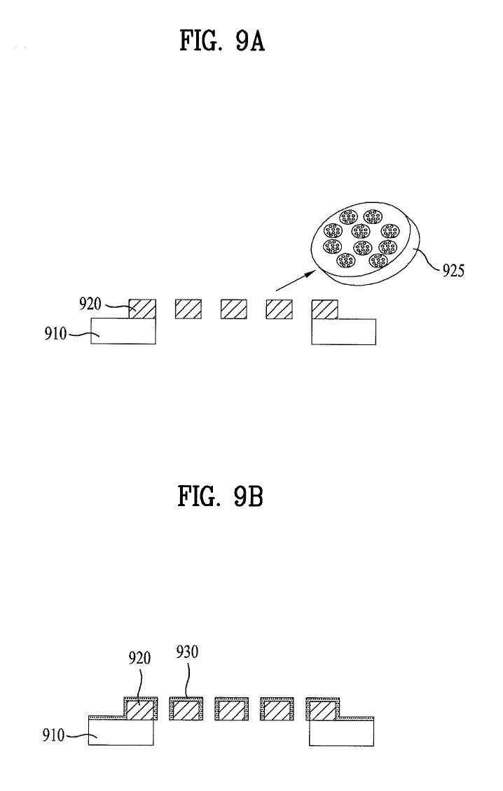

FIGS. 9A and 9B illustrate sections showing an example of the steps of a method for fabricating a water purifying filter of an SAM substance according to an embodiment of the present invention.

FIG. 9A illustrates a section showing the step of transcribing a nano-pore pattern formed according to the present invention. However, the step of transcribing a nano-pore pattern is similar to the pattern shown in FIG. 7F. That is, in the specification, for convenience's sake, the inventors intends to invoke the description made with reference to FIGS. 7A to 7F for the description of the steps of forming the nano-pore pattern with reference to FIG. 9A, and omits the detailed description with reference to FIG. 9A. However, nano-pore pattern in FIG. 9A is not limited to FIG. 7A to 7F, but may be referred to any one of FIGS. 2A to 2C, FIGS. 4A to 4D, FIGS. 5A to 5D and FIGS. 6A to 6B.

FIG. 9B illustrates a section showing the step of an SAM surface treatment 830 made on a UV-cured polymer pattern 820 after transcribing the nano-pore pattern formed in the step of FIG. 9A.

The SAM substance formed on the nano-pore as shown in FIG. 9B react with heavy metals selectively, enabling to collect or filter the heavy metals. The SAM substance coated on the surface may be, for an example, Thiol-SAM, Chelate-SAM, Anion-SAM, and HOPO-SAM. The Thiol-SAM can capture heavy metals, for an example, mercury Hg, silver Ag, gold Au, copper Cu, and cadmium Cd, selectively. The Chelate-SAM can capture heavy metals, for an example, copper Cu, nickel Ni, cobalt Co, Zinc Zn, and lead Pb, selectively. The Anion-SAM can capture, for an example, chromate and Arsenate, selectively. The HOPO-SAM has selectivity on americium Am, neptunium Np, plutonium Pu, thorium Th, and uranium U.

Moreover, the seventh embodiment can form a membrane in association with the fifth embodiment, and can fabricate a water purifying filter of the membrane formed thus. Besides, each one of the embodiments can form a membrane in association with at least one of the other embodiments and can fabricate a water purifying filter of the membrane formed thus.

Thus, the water purifying filter and the method for fabricating the same of the present invention have been described. As described, the water purifying filter of the present invention can improve endurance and an anti-fouling characteristic and can shorten a fabrication time period compared to the related art planar type filter by forming a customer tailored nano-membrane with a micro or nano pattern or SAM surface treatment on a surface of the filter, inducing that an entire water pressure is not applied to the water purifying filter, directly. Moreover, in comparison to the three dimensional structure, the water purifying filter of the present invention can reduce amounts of the aquaporin and the lipid bi-layer or the block copolymer to be used for fabrication of the water purifying filter, and has a short moving passage to increase the permeation rate of the water, too. And, in comparison to the nano-pore membrane formed by the related art semiconductor fabrication process, the present invention permits to obtain a low cost membrane, and increase endurance by applying the present invention to the aquaporin membrane. Eventually, the water purifying filter of the present invention can be applied to water treatment in general, starting from a domestic water purifier to a desalination plant, and to power generation system, such as the Pressure Retarded Osmosis PRO.

As has been described, the water purifying filter and the method for fabricating the same of the present invention have the following advantages. First, selective passage of only water can be made at a high permeation rate and a high salt removal ratio even at a low pressure. Second, the application of the polymer pattern transcribing technology to formation of the membrane for the water purifying filter enables to form the nano-membrane, easily. Third, the membrane formed of the membrane protein of the aquaporin group or the SAM substance enables to enhance a water purifying effect, further. Fourth, the water purifying filter can be fabricated adaptively by forming various types of membrane modules.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A water purifying filter comprising:
a support substrate;
a pattern layer formed on the support substrate, the pattern layer having at least one hole;
membrane protein of an aquaporin group provided on the pattern layer; and
a protective layer provided over the pattern layer having the membrane protein located thereon.

2. The water purifying filter as claimed in claim 1, wherein the support substrate is formed from one of an ultrafiltration membrane and a microfiltration membrane.

3. The water purifying filter as claimed in claim 1, wherein the protective layer is formed of a hydrophilic polymer.

4. The water purifying filter as claimed in claim 1, wherein the membrane protein is selected from one of:
an aquaporin vesicle formed in one of a lipid bi-layer and a block copolymer; and
aquaporin coated in one of a lipid bi-layer and a block copolymer.

5. The water purifying filter as claimed in claim 1, wherein the pattern layer is formed by using a mask or a mold.

6. The water purifying filter as claimed in claim 1, wherein the aquaporin group is selected from one of aquaporin 1 to aquaporin 12, aquaporin-Z, and aquaporin-M.

7. A water purifying filter comprising:
a support substrate, the substrate having a pattern with at least one hole;
membrane protein of an aquaporin group located at least partially in the pattern of the support substrate; and
a protective layer provided over the pattern of the support substrate.

8. A method for fabricating a water purifying filter, the method comprising:
forming a support substrate;
forming a pattern on the support substrate to have at least one hole;
coating membrane protein of an aquaporin group on the pattern; and
forming a protective layer on the pattern having the membrane protein coated thereon.
forming a protective layer on the pattern having the membrane protein coated thereon.

9. The method as claimed in claim 8, wherein the support substrate is formed from one of an ultrafiltration membrane and a microfiltration membrane.

10. The method as claimed in claim 8, wherein the membrane protein is selected from one of:
an aquaporin vesicle formed in one of a lipid bi-layer and a block copolymer,
and aquaporin coated in one of a lipid bi-layer and a block copolymer.

11. The method as claimed in claim 8, wherein the pattern is formed by using a mask or a mold.

12. The method as claimed in claim 8, wherein the aquaporin group is selected from one of aquaporin 1 to aquaporin 12, aquaporin-Z, and aquaporin-M.

13. The method as claimed in claim 8, wherein forming the pattern includes forming a polymer layer on the supporting substrate.

14. An intermediary for forming a water purifying filter comprising:
a first substrate;
a pattern layer formed on the first substrate to have a plurality of holes;
a second substrate having the pattern layer transcribed thereto;
membrane protein of an aquaporin group provided on the pattern layer; and
a protective layer formed over the pattern layer having the membrane protein provided thereon.

15. The intermediary for forming a water purifying filter as claimed in claim 14, wherein the first substrate is a polyethylene terephthalate (PET) substrate and the second substrate is a porous substrate.

16. The intermediary for forming a water purifying filter as claimed in claim 14, wherein the pattern layer is formed from a first film and a second film formed on the first substrate in succession, wherein the first film is formed of a water soluble polymer substance and the second film is an ultraviolet (UV)-cured substance.

17. The intermediary for forming a water purifying filter as claimed in claim 14, further comprising a self assembled monolayer (SAM) substance coated on the second substrate and the pattern layer.

18. The intermediary for forming a water purifying filter as claimed in claim 14, wherein the membrane protein is selected from one of:
an aquaporin vesicle formed in one of a lipid bi-layer and a block copolymer; and
aquaporin coated in one of a lipid bi-layer and a block copolymer.

19. A method for fabricating a water purifying filter, the method comprising:
coating a first film and a second film on a first substrate;
forming a pattern on the films coated on the first substrate;
transcribing the pattern to a second substrate;
removing the first substrate and the first film;
coating membrane protein of an aquaporin group on the second film having the pattern; and
forming a protective layer over the second film having the membrane protein coated thereon.

20. The method as claimed in claim 19, wherein the first substrate is a polyethylene terephthalate (PET) substrate and the second substrate is a porous substrate.

21. The method as claimed in claim 19, wherein the first film is formed of a water soluble polymer substance and the second film is an ultraviolet (UV)-cured substance.

22. The method as claimed in claim 19, further comprising a self assembled monolayer (SAM) substance coated on the second substrate and the pattern.

23. The method as claimed in claim 19, wherein the membrane protein is selected from one of:
an aquaporin vesicle formed in one of a lipid bi-layer and a block copolymer; and
aquaporin coated in one of a lipid bi-layer and a block copolymer.
